(19) United States
(12) Patent Application Publication
(10) Pub. No.: US 2007/0264363 A1
(43) Pub. Date: Nov. 15, 2007

(54) Molluscicidal and Anti-Barnacle Compounds

(75) Inventors: Ifor Delme Bowen, Cardiff (GB); Ahmed Yasine Ali, Roedovre (GB)

Correspondence Address: BANNER & WITCOFF, LTD., 1100 13th STREET, N.W., SUITE 1200, WASHINGTON, DC, 20005-4051, US

(73) Assignee: COMPTON DEVEOLOPMENT LTD, SWANASEA GREAT BRITAIN (GB)

(21) Appl. No.: 10/579,461

(22) PCT Filed: Nov. 12, 2004
(86) PCT No.: PCT/GB04/04765

§ 371 Date: Mar. 12, 2007

(30) Foreign Application Priority Data
Nov. 13, 2003 (GB) 032650.4

(51) Int. Cl. A01N 65/00; A01N 25/02; A01N 27/00; A01P 9/00; A01N 31/00

(52) U.S. Cl. 424/748; 424/725; 424/757; 514/729; 514/762; 514/763

(57) ABSTRACT

The present invention relates to the use of one or more compounds as a molluscicidal and/or mollusc-repellant agent, wherein the one or more compounds are terpenes or oxygenated derivatives thereof. The present invention also relates to a molluscicidal and/or mollusc-repellant agent comprising one or more of the compounds of the present invention. The present invention also relates to the use of one or more compounds as an anti-barnacle agent, wherein the one or more compounds are terpenes or oxygenated derivatives thereof. The present invention also relates to an anti-barnacle composition comprising the one or more compounds. The present invention also relates to the use of a plant extract as an anti-barnacle agent.

The present invention relates to the use of one or more compounds as a molluscicidal and/or mollusc-repellant agent. The present invention also relates to a molluscicidal and/or mollusc-repellant agent comprising one or more of the compounds of the present invention. The present invention also relates to the use of one or more compounds as an anti-barnacle agent. The present invention also relates to an anti-barnacle composition comprising the one or more compounds. The present invention also relates to the use of a plant extract as an anti-barnacle agent.

Molluscs, especially slugs and snails cause considerable damage to crops and plants, and are therefore a pest to domestic gardeners as well as farmers. Current methods of controlling slugs and snails rely on the broad application of synthetic chemicals such as metaldehyde and methiocarb. There are a number of problems with using such chemicals, including the relatively high cost of the chemicals, the toxicity risks. of storing and using such chemicals, and environmental problems, such as biodegradability and the toxic effects of the compounds on non-target organisms.

There is therefore a need for a new method of preventing damage to crops and plants caused by molluscs.

A wide range of plants is known to be of use in controlling aquatic molluscs. These are reviewed and listed in “Plant Molluscicides”, edited by Mott K. E. (1987) UNDP/World Bank/WHO Special Programme for Research and Training in Tropical Disease. John Wiley and Sons Ltd. These plants are not ure to control terrestrial molluscs since most of them are dispersed by water and exert a surfactant effect. The book emphasises plants such as Endod (Phytolacca dodecandra), which produces a saponin. Most of these appear to work as aquatic molluscicides affecting surface tension at the gills of aquatic snails and leading to toxic haemolytic effects. Evidence suggests that they act by affecting cell membrane integrity (Henderson T. O., Farnsworth N. R and Myers T. C. (1987) Biochemistry of recognised molluscicidal compounds of plant origin, Chapter 4, In Plant Molluscicides, Ed. K. E. Mott. pp. 109-130). Such plants or their extracts are not used to control terrestrial molluscs, which are usually controlled by neurotoxins (Henderson I. And Triebskorn R. (2002) Chemical control of terrestrial gastropods. Chapter 12. in Molluscs as Crop Pests, Ed. G. M. Baker, CABI Publishing, pp. 1-31).

In particular, three plants indigenous to Nigeria, i.e. Detarium microcarpum, Ximenia americana and Polygonum limbatum, are known to have molluscicidal activity against aquatic snails (see Kela et al., Revue Elev. Med. vet. Pays trop., 1989, 42(2), 189-192; Kela et al., Pesticide Outlook, 1995, 6(1), 22-27; Arthur et al., Slug & Snail, Pests in Agriculture BCPC Symposium Proceedings, 66, 389-396, 1996). JP-A-6216477 discloses that extracts of plants belonging to Pittosporaceae, Polygonaceae, Oleaceae or Gramineceae can be used in a composition to prevent aquatic molluscs from adhering to ships.

WO 00/04781 and U.S. Pat. No. 5,290,557 relate to saponin containing plant extracts obtained from Yucca shidegra, Quillaja saponaria and Hedera helix.

Co-pending International PCT Patent Application PCT/GB03/001936 describes the use of plant material derived from a plant in the plant family Caesalpiniaceae, Olaceae, Polygonaceae or Bursecaceae as a terrestrial molluscicidal and/or mollusc-repellent agent.

The plant materials used include plant extracts such as alcoholic plant extracts but the actual active compound or compounds that have the molluscicidal and/or mollusc-repellent activity are unknown. This means that the plant materials used will have other compounds present and that these other compounds may have negative or harmful effects. For example the other compounds may be harmful to certain plants or other animals, or may inhibit the molluscicidal and/or mollusc-repellent activity of the plant material. Furthermore, by identifying the specific compound or compounds that have the molluscicidal and/or mollusc-repellent activity one can synthesis the compound using standard chemistry instead of by having to isolate it from the actual plant material. The structure of the active compound or compounds may be altered to improve their function, for example, by modifying the solubility, modifying the molluscicidal and/or mollusc-repellent activity, modifying the stability, etc.

When plants are damaged or bacterially infected they produce secondary metabolites, such as terpenes, as a defence against pathogens and invading pests. Theses secondary metabolites also behave as a chemical defence, for plants, against being eaten by herbivores. Plants therefore contain an untapped reservoir of pesticides that may have potential for use in the agrochemnical industry.

The present application is directed to a specific group of compounds, which generally fall into the category of terpenes. A terpene is a natural compound made up of isoprene units (5 carbon units) joined together head to tail in a regular pattern. Monoterpenes are the simplest family of isoprenoids and contain two isoprene units (10 carbon units). Sesquiterpenes are more complicated terpenes, which are linked by 3 isoprene units (15 carbon units).

In U.S. Pat. No. 5,196,200 it is indicated some related sesquiterpenes behave as insect repellents against houseflies and mosquitoes. In particular, a mixture of bisabolene isomers was found to be effective against Musca domestica L. (Diptera:Muscidae) and Aedes aegypti.

Powell and Bowen (Slug and Snail Pests in Agriculture, BCPC Symposium Proceedings, 66, 261-236, 1996) selected certain monoterpenes as candidates for testing against the field slug, D. reticulatum, and found thymol, menthol and α-terpineol to be effective mollusc repellents. They also showed menthol, menthone and carvone to be potent molluscicides.

Iglesias et al., (Proceedings of OILB/IOBC Working Group on Integrated Control of Soil Pests, Subgroup on Integrated Control of Slugs and Snails meetings, Lyon, France 2001) also found carvone to be a highly effective molluscicide when tested against the eggs of D. reticulatum. Carvone applied at a rate of 4.6 kg/ha was shown to induce death in 2 days.

Dodds (Slug and Snail Pests in Agriculture, BCPC Symposium Proceedings, No. 66, 335-340, 1996) confirmed the antifeedant properties of (+) fenchone, a bicyclic monoterpene, isolated from the plant curled chervil (Anthriscus cerefolium), using electrophysiological techniques.

Khallouki et al., (Fitoterapia, 71, 544-546, 2000) discloses the antibacterial and molluscicidal activities of the essential oil of Chrysanthenum viscidehirtum but does not disclose the activity of individual components of the essential oil.

Japanese patent application JP 01294601A describes the use of alllo-ocimene as a repellent against a variety of animals. Allo-ocimene has a different structure when compared with trans-β-ocimene and cis-β-ocimene.

French patent application FR 2697133A suggest that a number of sesquiterpenes are useful as molluscicidal agents.

The identification of new and preferably more effective molluscicidal and/or mollusc repellent agents is desirable so that an effective and environmentally friendly agent can be used to prevent damage to plants and crops.

The present invention also relates to anti-barnacle agents. Barnacles are the major source of marine fouling. They normally settle on any surface offered up in the natural marine environment and are a major cause of the fouling of boat and ship hulls (Callow and Callow, Biologist, 49, 1-5, 2002). The fouling of hulls by marine organisms especially barnacles slows down ships and boats. This has accumulating costs in terms of fuel use and time lost, eventually leading to the increased costs of time out in dry dock to clean hull surfaces. Good anti-fouling paints can greatly reduce these costs. There is thus a vast demand for new non-toxic anti-fouling agents not only for shipping, including ocean liners, but also for offshore constructions, oil rigs, pulp and paper mills, water treatment plants and fish farming nets.

Kitano et al., (Tennen Yuldc Kagobutsu Toronlcai Koen Yoshihui (2001), 43^{rd}, 569-573) discloses the use of bisabolene type terpene as an anti-barnacle agent.

Japanese patent application JP 04295401A discloses the use of bisaboren as an anti-fouling agent.

United Kingdom patent 1567819 discloses the use of a number of sequiterpene compounds as anti-fouling agents.

A very strong impetus for the invention of environmentally friendly anti-barnacle agents is the fact that from 2003 the International Maritime Organisation has banned the use of the currently most widely used anti-barnacle paints containing tributyltin (TBT) on the basis of its environmental toxicity. All TBT based anti-barnacle paints are to be phased out by 2008. This is urgent since residues of TBT have been found throughout the world, particularly in sediments near shipping activity where it is especially toxic to shellfish.

Some countries such as New Zealand and Japan have already banned TBT paints and in Australia only vessels larger than 25 meters are for an interim period allowed to use these paints. Currently, the main short-term alternative to TBT paints are copper based. These are however not as effective and have also been found to be toxic to marine organisms. Copper based paints are thus seen only as a “bridging solution”, until the development of non-toxic anti-barnacle products.

According to a first aspect of the present invention there is provided a composition comprising an isolated compound in combination with one or more carriers, for use as a molluscicidal and/or mollusc-repellent agent, wherein the compound is a terpene or oxygenated derivative thereof, the terpene is selected from:
I) 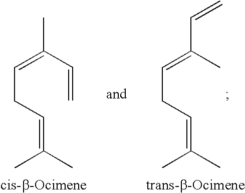
II) monocyclic sesquiterpenes of the bisabolene, bisabolol or germacrene type; and
III) bicyclic sesquiterpenes of the santalene or carophyllene type.

The compound used in the composition of the present invention must have molluscicidal and/or mollusc-repellent activity. It has been found that the specific terpene compounds identified above all have molluscicidal and/or mollusc-repellent activity.

Representative terpenes of the bisabolene type include:

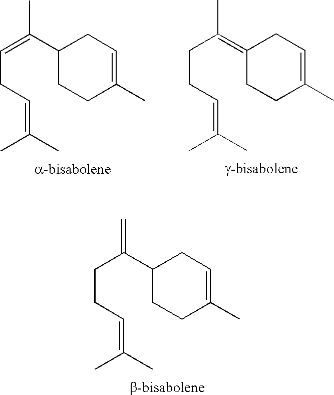

A preferred terpene of the bisabolol type is

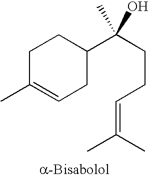

Representative terpenes of the genmacrene type include:

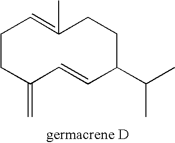

Representative telpenes of the santalene type include: 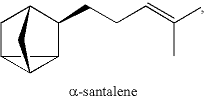
and of the caropliyllenle type include: 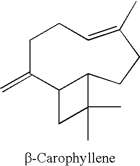
and oxygenated derivatives of the santalene type include:

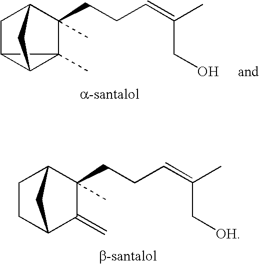

It is particularly preferred that the compound used in the composition of the present invention is selected from the representative compounds indicated above. Minor modifications within the general formulae of the terpenes of the present invention can be made provided the modified compound has molluscicidal and/or mollusc-repellent activity. Minor modifications including replacing a side group with a closely related side group that would not be considered to destroy the activity of the compounds, e.g. replacing —CH₃ with —CH₂CH₃. Those sildled in the art are well aware of appropriate modifications that can be made to the terpene compounds encompassed by the general formulae given above without destroying the activity of the compounds.

The term “isolated compound” means that the compound has been isolated from the other components with which it is naturally found. The one or more carriers are mixed with the compound to form the composition. In PCT/GB03/001936 plant material or crude plant extracts are used and the active molluscicidal compound has not been isolated.

Two or more of the isolated compounds may be used in conjunction as a molluscicidal and/or mollusc-repellent by using them simultaneously, sequentially or separately. The composition may comprise two or more of the terpene compounds.

The term “molluscicidal and/or mollusc-repellant” as used herein means that the agent kills and/or repels a terrestrial or aquatic mollusc. The term “terrestrial mollusc” as used herein means any mollusc that lives in a terrestrial environment for the majority of its lifetime. Particular examples of terrestrial molluscs include slugs of the genera Arionidae, Milacidae, Boettgerillidae and Limacidae, and snails of the genera Helix, Cantareus, Bradybaenea, Candidula, Carychium Cecilooides, Cernuella, Cochlicopa, Cepea, Eobania, Discus, Euomphalia, Galba, Helicella, Helicigonia, Helicodiscus, Lacinaria, Monacha, Tymnaea, Retinella, Vertigo, Vitrea Oxychilus, Physa, Succinea, Trichia, Vallonia, and Zonitoides. A particularly preferred terrestrial molluscs is the grey field slug Deroceras reticulatum. The term “aquatic mollusc” as used herein means any mollusc that lives in an aquatic environment for the majority of its lifetime. The aquatic mollusc may be a fresh water or salt water mollusc. Particular examples of aquatic molluscs include molluscs of the genera Biomphalaria, e.g. B. glabrata, B. pfeifferi, B. havaiiensis, B. sudanica, B. cenagophilia; Bulinus, Ceirithiium, Clarius, Dreissena, e.g. D. polymorpha; Heliosoma, Lymnea, e.g. L. stagnalis, L. natalenisis; Marisa, Oncomelania, e.g. O. quadrasis; Phelidole, Phernaea, Physa, e.g. P. occidentalis; Planorbis, Pomacea, e.g. P. Canaliculata, Tanebria, and Sepedon.

The compound used in the composition of the present invention can preferably be obtained from a plant in the genera Detarium, Ximenia, Polygonum, Commiphora or Boswellia. In particular, it is preferred that the compound can be obtained from the plant Detarium microcarpum, Ximeniia americana, Polygonum limbatum, Commiphora molmol, Commiphora guidotti or a Boswellia sp.

Detarium microcarpum, Ximenia americana and Polygonum limbatum are indigenous to Nigeria and as indicated above are known to have molluscicidal activity against aquatic snails. These three plants are referred to herein as afribark plants and have been found to have both molluscicidal and mollusc-repellent effects on terrestrial molluscs.

Commiphora molmol, Commiphora guidotti and Boswellia sp. are indigenous to the “Horn of Africa” (Somalia and Ethiopia). Furthermore, exudates from Commiphora molmol and Commiphora guidotti, when hardened, are kcnown commercially as myrrh and scented myrrh. Commiphora molmol, Commiphora guidotti and Boswellia sp. are together herein referred to as odoriferous oleoresins and are icnown in Africa to repel insects and snakes. This has also been confirmed experimentally. Commiphora molmol has been shown to be larvicidal to mosquitoes (Massoud et al., Journal of the Egyptian Society of Paracitology, 3, 101-115, 2000), while Commiphora guidotti has been found to have repellent and toxic effects against ticks (Maradufu, Phytochemistry, 21, 677-680, 1982; Carroll et al., Entomol. Exp. Appl., 5, 111-116, 1989). It is indicated in PCT/GB03/001936 that the odoriferous oleoresins have molluscicidal and/or mollusc-repellent activity on terrestrial molluscs.

The compound used in the composition of the present invention can be obtained by isolating it from the appropriate plant indicated above. In particular, the majority of the compounds that can be used in the composition of the present invention can be isolated from Commiphora inolmol or Commiphora guidotti. The compound can be isolated using any suitable preparative method. Methods of isolating such compounds are known to those skilled in the art and include chromatographic methods such as flash column chromatography and solid phase extraction columns. Nuclear Magnetic Resonance and Mass Spectrometry can be used to identify the individual compounds.

When the compound used in the composition of the present invention is isolated from a plant, substantially no contaminating plant material is present. Substantially no contaminating plant material means that less than 0.1% (w/w) of contaminating plant material is present.

The compound used in the composition of the present invention may be obtained from commercial sources such as Sigma-Aldrich Ltd (cis-Ocimene), RC Treat Ltd (trans-β-Ocimene; γ-bisabolene; Germacrene D and Carophyllene) and KIC Inc., New York, USA (α-bisabolol). The compound of the present invention may also be synthesised using standard chemical synthesis procedures.

The composition of the present invention comprises the compound and a carrier. The carrier is a heterologous carrier, i.e. the carrier is not associated with the compound in nature. In other words, the carrier is not associated with the compound in the plant from which the compound can be obtained. The type of carrier used will depend on how the composition is to be used, for example if the composition is to be used as a spray, it is preferred that the canier is a suitable aqueous solution such as an alcoholic solution preferably comprising 1 to 10% alcohol in water. The carrier can also be an aqueous non-ionic surfactant such as Tween 80 and Tween 20 (0.1-5%), or aqueous DMSO (about 10%). The carrier can also be an inert oil of plant origin, such as vegetable oil, corn oil and maize oil. Alternatively, the compound may be used in combination with a solid material.

In a preferred embodiment the carrier is a solid material. Any solid carrier material can be used such as a powder or a particulate.

It is particular preferred that the carrier is a particulate.

The term “particulate” as used herein refers to any substance, which is in the form of particles, which are of a sufficient size so as to act as an irritant to the movement of a terrestrial mollusc. In particular, it is preferred that the particulate is sand, sharp sand, pumice granules, sawdust, woodchips or corn cob chips. The particles, or at least the majority of the particles (for example about 90% of the particles by weight), are preferably between about 0.5 and 5 millimeters in diameter.

It is particularly preferred that the particulate is either sawdust or sharp sand.

The compound may be combined with a particulate by mixing or spraying the particulate with the compound.

It has been found that by combining the compound with a particulate that better protection of plants is obtained. It appears that the combination of the compound and the particulate forms a barrier to the molluscs. Therefore, by distributing the particles, which have been impregnated or coated with the compound, around plants to be protected, a barrier will be formed protecting the plants from molluscs.

The use of a particulate also has the added advantage of improving the friability, drainage and tilth of the soil. Furthermore, some particulates, e.g. sawdust and corncob, are biodegradable and degrade into a mulch, which improves the soil.

In an alternative preferred embodiment the carrier is a liquid. When the composition is to be used in a liquid form, it is preferably sprayed. The advantage of spraying the composition is that it can be easily delivered over large areas. Furthermore, the composition can be sprayed onto soil, plants or seeds in order to kill and/or repel molluscs. In a preferred embodiment, the composition is in a formulation capable of being sprayed on to plants or seeds. A spray formulation may additionally comprise an emulsifying agent, such as tween 80.

The concentration of the composition is preferably selected so it is molluscidal/mollusc-repellant, but riot toxic to non-mollusc species. More preferably the concentration is selected so that the composition is mollusc-repellant, but not molluscidal.

Preferably the composition contains between 0.1 and 5% compound, more preferably between 0.1 and 3% compound, most preferably between 0.25 and 1% compound.

The carrier is preferably selected for polarity. The inventors have surprisingly found that increasing the polarity of the carrier increases the molluscicidal and mollusc-repellant properties of the composition.

In a further embodiment of the present invention, the composition of the present invention is preferably combined with or used in conjunction with an effector agent.

The effector agent may be any agent, which provides a beneficial effect to the plant or crop being protected from the molluscs. Suitable effector agents include fertilisers, fungicides and pesticides.

The composition of the present invention and an effector agent may be used in conjunction by using them simultaneously, sequentially or separately. Preferably, the composition and the effector agent are combined together and used simultaneously.

The composition may be applied to surfaces such as wall, paths, etc. For example, the composition may be formulated as a paint-lilce preparation, which can be painted or sprayed onto surfaces. The composition may be used in an aqueous environment by, for example, applying it to boat hulls, the sides of docks or fishing nets. Paint compositions comprising chemical molluscicidal and/or mollusc-repellent agents are known and one skilled in the art could modify these known paint compositions by incorporating the compound as defined above.

According to a second aspect of the present invention, there is provided the use of the isolated compound referred to in the first aspect of the present invention as a molluscicidal and/or mollusc-repellent agent.

Preferably the isolated compound is combined with one or more carriers as described with respect to the first aspect of the present invention.

As indicated above, the type of carrier used will depend on the agent, for example if the preparation is a spray, it is preferred that the carrier is a suitable aqueous solution such as an aqueous methanol or ethanol solution, or an inert oil of plant origin, such as vegetable oil, corn oil and maize oil.

Alternatively, if the agent is comprised of solid material, it is preferred that the carrier is a particulate as defined above with respect to the first aspect of the present invention.

In accordance with the first aspect of the present invention the isolated compound may be used in combination with an effector agent. The effector agent is as defined above with respect of the first aspect of the present invention.

In accordance with the first aspect of the present invention the isolated compound may be used as a molluscicidal and/or mollusc-repellant of both aquatic and terrestrial molluscs. Preferably, the isolated compound is used as a molluscicidal and/or mollusc-repellant of terrestrial molluscs.

According to a third aspect of the present invention, there is provided the use of plant material derived from a plant in the plant family Caesalpiniaceae, Olaceae, Polygonaceae or Bursecaceae as an anti-barnacle agent.

It has been found that the use of plant material derived from plants within the above mentioned plant families acts as an anti-barnacle agent. It is assumed that the plants contain an anti-barnacle activity. The activity may be a single compound or a group of compounds.

The plant materials have previously been used as molluscicidal and/or mollusc-repellent agents but as the physiology of molluscs is substantially different from that of barnacles, it is surprising that the plant inrials have anti-barmacle activity. The term “anti-bamacle” as used herein means that the agent kills and/or repels barnacles. The term “barnacle” as used herein means any marine crustacean of the class Cirripedia that can attach itself to a solid surface such as the hull of a boat, sea walls, etc. Particular examples of barnacles include Balanus amphitrite.

Preferably, the plant material is obtained from a plant in the genera Detarium, Ximenia, Polygonum, Commzphora or Boswellia. In particular, it is preferred that the plant material is obtained from the plant Detarium microcarpum, Ximenia americana, Polygonum limbatum, Commiphora molmol, Commiphora guidotti or a Boswellia sp. Most preferably the plant materials is obtained form Commiphora molmol or Commiphora guidotti.

The plant material used in the present invention may comprise substantially the whole plant or particular parts of the plant, such as resinous exudates, that have anti-barnacle activity. Preferred parts include the bark, leaves or shoot of the plant. Preferably, such plant material is ground to particles or to a powder before use. The particles are preferably of a few millimeters in diameter (e.g. from 0.5 to 10 mm in diameter).

Alternatively, it is preferred that the plant material is an extract derived from the plant, wherein the extract has anti-barnacle activity. The extract is preferably an alcoholic extract and may be obtained using standard procedures for obtaining alcoholic extracts of the plant. In particular, methods for obtaining such an alcoholic extract are well known to those sldlled in the art. Alternatively, it is preferred that the plant material is an alcoholic extract of an essential oil of the plant. Essential oils are the volatile, organic constituents of fragrant plant matter. Essential oils are generally extracted from plant by two main methods, distillation (steam, water or dry distillation) and cold pressing. A plant extract containing mainly oils can also be prepared using solvents, carbon dioxide extraction or hydrofluoroalkanes. Tincture plant extracts can be made by macerating the plant materials and extracting using aqueous, ethanolic solvents (70%-90% ethanol in water) and left for a period of time, after which the solid debris is filtered.

In a particular preferred embodiment, the plant material is a substantially isolated compound or mixtures of compounds having anti-barnacle activity. Methods of isolating such comnpounds are known to those slilled in the art and include chromatographic methods. For example, the essential oils of the plant can be extracted by steam distillation. The oil collected can be dried over anhydrous sodium sulphate and filtered. The oil can then be solubilised in hexane or dichloromethane and analysed using GC/MS and TLC equipment. Further purification of extracts from all sources can be performed using flash column chromatography and solid phase extraction columns. Nuclear Magnetic Resonance and Mass Spectrometry can be used to identify the individual compounds.

The term “substantially isolated” means that the molluscicidal and/or mollusc-repellant compound or compounds are substantially isolated from the plant. Preferably, the molluscicidal and/or mollusc-repellant compound or compounds comprise less than 5% (w/w), more preferably less than 1% (w/w) of contaminating plant material.

The plant material of the present invention is preferably used in combination with a carrier. The type of carrier used will depend on how the plant material is to be used, for example if the plant material is to be used as a spray, it is preferred that the carrier is a suitable aqueous solution such as an alcoholic solution preferably comprising 1 to 10% alcohol in water. The carrier can also be an inert oil of plant origin, such as vegetable oil, corn oil and maize oil. Alternatively, if the plant material is to be used as a paint, any paint base can be used.

The plant material is preferably applied to surfaces to repel molluscs from the surfaces. The plant material may be made into suitable preparations for applying to surfaces such as paint-lilke preparations that can be painted or sprayed onto surfaces.

In a further embodiment of the present invention, the plant material is preferably used in conjunction with an effector agent.

The effector agent may be any agent that provides a beneficial effect. Suitable effector agents include complementary anti-barnacle agents.

Preferably, the plant material and the effector agent are combined together and used simultaneously.

It is particularly preferred that the plant material is used as a paint-like preparation which can be painted or sprayed onto surfaces. It is also preferred that the preparation is used in an aqueous environment by, for example, applying it to boat hulls, the sides of docks or fishing nets. Paint compositions comprising chemical anti-barnacle agents are icnown and one skldled in the art could modify these known paint compositions by incorporating the plant material as defined above.

According to a fourth aspect of the present invention there is provided an anti-barnacle composition comprising an isolated compound in combination with one or more carriers for use as an anti-barnacle agent, wherein the compound is cis-β-ocimene or trans-β-ocimene, or an oxygenated derivative thereof.

The composition is preferably suitable for applying to surfaces that come into contact with barnacles.

The type of carrier used will depend on how the compound is to be used, for example if the anti-barnacle composition is to be used as a spray, it is preferred that the carrier is a suitable aqueous solution such as an alcoholic solution preferably comprising 70 to 90% alcohol in water. Alternatively, if the anti-barnacle composition is to be used as a paint, any paint base can be used.

The anti-barnacle composition is preferably applied to surfaces to repel barnacles from the surfaces. The plant material may be made into suitable preparations for applying to surfaces such as paint-like preparations that can be painted or sprayed onto surfaces.

The anti-barnacle composition preferably comprises between 0.1 and 50% v/v compound, more preferably between 3 and 25%, most preferably between 6 and 25%.

In a further embodiment of the present invention, the anti-barnacle composition is preferably used in conjunction with an effector agent.

The effector agent may be any agent that provides a beneficial effect. Suitable effector agents include complementary anti-barnacle agents.

Preferably, the anti-barnacle composition and the effector agent are combined together and used simultaneously.

It is particularly preferred that the anti-barnacle composition is used as a paint-like preparation which can be painted or sprayed onto surfaces. It is also preferred that the preparation is used in a aqueous environment by, for example, applying it to boat hulls the sides of docks or fishing nets. Paint compositions comprising chemical anti-barnacle agents are known and one sidlled in the art could modify these known paint compositions by incorporating the anti-barnacle composition as defined above. As will be appreciated by those sidlled in the art, as the anti-barnacle composition is used as an anti-barnacle agent, it preferably comprises a carrier that enables it to be applied to surfaces on which the attachment of barnacles is to be reduced or prevented. Carriers such as paint bases are particularly suitable.

According to a fifth aspect of the present invention, there is provided the use of the isolated compound referred to in the fourth aspect of the present invention as an anti-barnacle agent.

Preferably the isolated compound is combined with one or more carriers as described with respect to the fourth aspect of the present invention. The isolated compound is preferably used in the concentrations described with respect to the fourth aspect of the present invention.

In accordance with the fourth aspect of the present invention the isolated compound may be used in combination with an effector agent. The effector agent is as defined above with respect of the fourth aspect of the present invention.

The present invention also provides a method of forming a stable water emulsion comprising an essential oil, a surfactant and water, wherein the essential oil and the surfactant are mixed together prior to additoin of the water.

A stable water emulsion is a single homogenous mixed phase having a turbid appearance, wherein the turbid appearance is maintained for more than one week.

An essential oil is as defined above, namely volatile organic constituents of fragrant plant matter.

The surfactant can be any suitable surfactant such as an alcohol, Tween 20 or 80, DMSO, etc.

It has been found that by mixing the essential oil and the surfactant together prior to addition of water that a stable emulsion is obtained.

The present invention is now described, by way of example only, with reference to the accompanying figures in which:

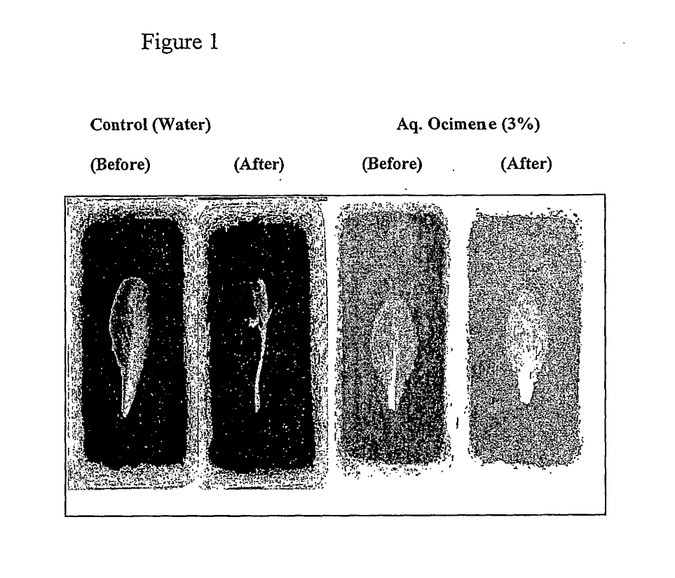

FIG. 1 shows the slug induced lettuce leaf damage before and after spraying with a 3% aqueous solution of trans-β-ocimene.

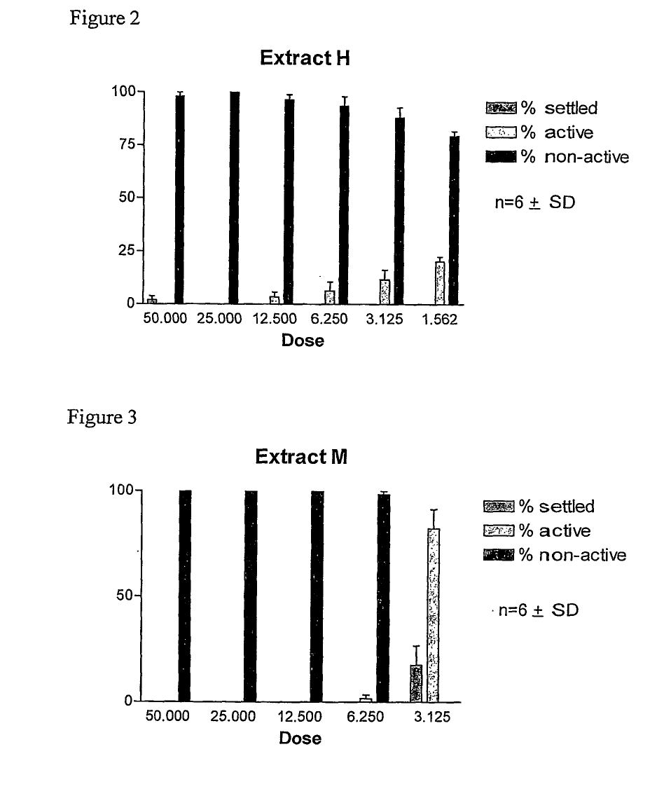

FIG. 2 shows the barnacle settlement results when using an extract from Commiphora guidotti (extract H).

FIG. 3 shows the barnacle settlement results when using an extract from Commiphora molmol (extract M).

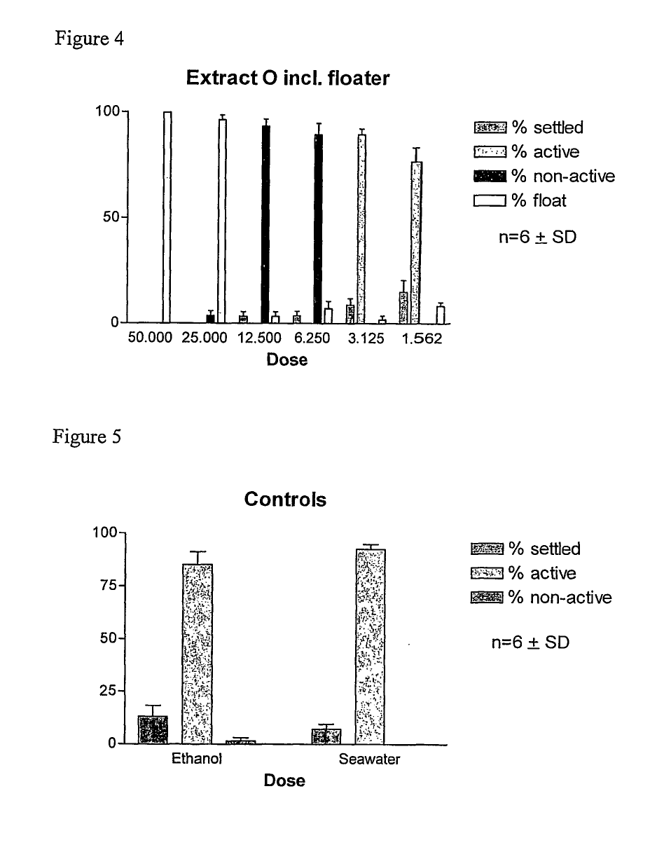

FIG. 4 shows the barnacle settlement results when using trans-β-ocimene (compound O).

FIG. 5 shows the use of ethanol and seawater in the barnacle settlement experiments by way of a control.

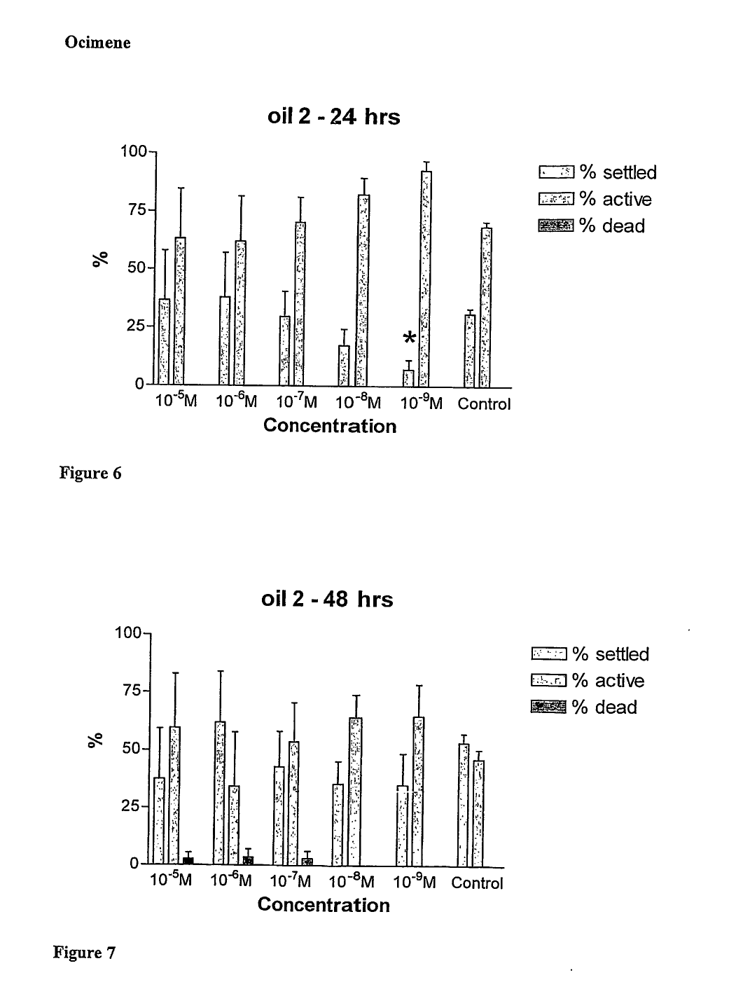

FIG. 6 shows the percentage of barnacle cyprids that settled active or dead after 24 hours incubation with varying concentrations of trans-β-ocimene.

FIG. 7 shows the percentage of barnacle cyprids that settled active or dead after 48 hours incubation with varying concentrations of trans-β-ocimene.

### EXAMPLES

### Examples—Molluscicidal and Mollusc-Repellent Compounds

Materials and Methods

Reagents

Absolute ethanol and hexane (HPLC grade) were obtained from Fischer Scientific (UK).

The following reagents and chemicals were purchased from Sigma-Aldrich limited, Dorset: Dimnethyl sulfoxide (D.M.S.O) (99.5% purity), Tween 80 and Tween 20 (Polyoxyethlenesorbitan monooleate), cis-Ocimene (purity 70%), trans,trans-Famesol (purity 96%), cis,trans-Farnesol (purity 95%), myrrh essential oil and opoponax essential oil.

The following chemicals were lindly provided by R C Treat limited, Suffollc: trans-βOcimene (purity 90%), γ-bisabolene (purity 70%), Germacrene D (purity 40%), Carophyllene (purity 96%), α-Farnesene (purity 70%).

The compound α-bisabolol may be obtained from IUC Inc., New York, USA.

Pure Sandalwood essential oil (santalum album), Tisserand Aromatherapy, was purchased from Neal Yards Remedies, Cardiff.

The surfactant Synperonic 91/8 was obtained from Grotech Production Limited (Goole, Yorlkshire).

Test Animals

Adult D. reticulatum were collected from nearby fields and maintained in plastic trays lined with moist, unbleached, absorbent paper They were housed in the dark and at a constant temperature of 10°±1° C. Slugs were regularly fed on a mixture of iceberg lettuce and carrots. Slugs, with a weight 300-600 mg, were pre-starved for 24 hours and maintained at a constant temperature of 15°±1° C. prior to testing.

Preparation of Test Materials

The oils of sandalwood, trans-β-ocimene and α-bisabolol were prepared as oil in water emulsions by adding to them various aqueous surfactants. The oils were weighed, into a stoppered glass vial. To this was added, the selected surfactant and vortex mixed for approximately 2 minutes, using a Whirli™ mixer (Fisons). The formulation was diluted to volume (10 ml) with deionised water. This formulation was vigorously vortex mixed again for 2 minutes.

It is important that the water is not added to the mixture until the oil and surfactant have been blended together (generally at least 2 minutes). It has been found that if this order of addition is not followed the stability of the emulsion produced will be adversely affected. Our definition of a stable emulsion is the formation of one homogenous phase mixture comprising a turbid appearance. If the emulsion is stable for 24 hours it is classed as a short-term stable emulsion whilst if no changes in appearance occurs over a time period greater than 1 week it can be classed as long term stable emulsion.

The terpene oils listed, above, were prepared in different media as shown below:

i) Ethanol

A lanown weight of terpene oil was weighed into a 10 ml volumetric flask and diluted to volume with absolute ethanol.

ii) DMSO Extracts (10%)

A Known weight of terpene oil was weighed into a 10 ml volumetric flask containing 1 g of drnso. This was lightly mixed and diluted to volume with water resulting in essential oil final concentrations of 0, 0.5, 1 and 5% w/v. This was vortex mixed to form an emulsion.

iii) Tween 80 Extracts (0.2%)

A known weight of terpene oil was weighed into a 10 ml volumetric flask containing 0.02 g of tween 80. This was lightly mixed and diluted to volume with water. This was vortex mixed to form an emulsion.

iv) Tween 80 Extracts (0.5%)

A known weight of terpene oil was weighed into a 10 ml volumetric flask containing 0.05 g of tween 80. This was lightly mixed and diluted to volume with water. This was vortex mixed to form an emulsion.

v) Water Extracts

A known weight of terpene oil was weighed into a 10 ml volumetric flask and diluted to volume with water. This was vortex mixed to form an emulsion.

Bioassy

The technique described here is a no choice-feeding bioassay using circular discs prepared from lettuce leaves. Selected terpenes were tested against D. reticulatum slugs and evaluated for their repellent/antifeedant and molluscicidal properties.

Leaf Disc Assay Method

Lettuce leaf discs (1.4 cm²) were placed in petri dishes lined with water saturated filter paper (9 cm² diameter). A known concentration of terpene oil, solubilised in the appropriate media, was prepared and a fixed volume (50 μl) added by pipette, onto individual lettuce leaf discs. Any residual solvent was left to evaporate for a minimum time of 30 iminutes.

Slugs, previously starved for 24 hours, were introduced to the petri dishes and placed in an environmentally controlled chamber (15° C.: 12 hours day, 15° C.: 12 hours night) for 24 hours.

The amount of leaf disc damaged (eaten) was quantified by comparing digital photographs of treated leaf discs with untreated (control) leaf discs, using photographic computer software. The experiment was replicated 20 times for each terpene.

To compare the change in feeding behaviour for different treatments, the leaf damage data was corrected for the control, using the repellency index equation below.

$$R . I ( \% ) = 100 \times \frac{leaf disc area ( control ) - \% leaf disc area ( treatment )}{leaf disc area ( control )}$$

The antifeedant effect of various media was determined by comparison to untreated leaf discs. A positive R I value indicates a reduction in feeding (antifeedant/repellent) whereas a negative value indicates an increase in feeding behaviour (phagostimulant). Corrections for mortality were done the Abbotts formula (Abbott, 1925).

$$\begin{matrix}Corrected \\ Mortality \\ ( \% )\end{matrix} = \frac{observed \% mortality - control \% mortality}{100 - control \% mortality} \times 100$$

Bioassay Assay Results: Leaf Disc Assay

### Example 1

TABLE 1
Change in feeding behaviour and molluscicidal activity after treating
leaf discs treated with different media

| | Repellency Index | Corrected Mortality |
|---|---|---|
| Solvent | (%) | (%) |
| Ethanol | 0.4 | 0 |
| Aqueous dmso (10%) | −2 | 0 |
| Aqueous dmso (2.5%) | 5 | 0 |
| Aqueous tween 80 (0.2%) | 0.5 | 0 |
| Aqueous tween 80 (0.5%) | 8 | 0 |
| Water | 0 | 0 |

The different media used to solubilise the terpenes, had no adverse repellent or antifeedant effects towards the feeding behaviour of D. reticulatum.

### Example 2

TABLE 2
Change in Feeding behaviour and mortality after treating leaf discs with
the trans isomer of β-Ocimene (0.45%) in different media

| | | | Corrected |
|---|---|---|---|
| | | Repellency Index | Mortality |
| Sample description | Solubilising Media | (%) | (%) |
| trans-β-Ocimene | Ethanol | 35 | 0 |
| (0.45%) | Aq. Tween 80 | 73 | 10 |
| | (0.5%) | | |
| | Aq. Tween 80 | 91 | 20 |
| | (0.2%) | | |
| | Aq. Dmso (2.5%) | 91 | 20 |
| | Aq. Dmso (10%) | 90 | 70 |
| | Water | 100 | 90 |

Example 2 confirms the repellent and molluscicidal nature of the monoterpene trans-β-ocimene. When formulated as an aqueous emulsion, with a non-ionic surfactant (0.2 and 0.5% tween 80), it reduces leaf consumption by 73 to 91%. Changing the media to 5 aqueous dmso (10%) increased the molluscicidal behaviour, whilst maintaining its repellency properties. The molluscicidal properties of ocimene increased, again, when only water was used as an emulsion formulation. No leaf disc consumption was observed resulting in 100% repellency. There is clear relationship between the repellency properties of trans-β-ocimene and the polarity of the media that is used to formulate the treatrnents. It is therefore concluded that increasing the polarity of the media increases the repellency and molluscicidal properties of trans-β-ocimene.

TABLE 3
Change in Feeding behaviour and mortality after treating leaf discs
with the trans isomer of β-Ocimene (0 to 3%) in aqueous dmso (10%)

| | | | Corrected |
|---|---|---|---|
| | trans-β-Ocimene | Repellency Index | Mortality |
| Media | (%) | (%) | (%) |
| Aq. Dmso | 0* | 3 | 0 |
| (10%) | 0.22 | 2 | 0 |
| | 0.45 | 90 | 70 |
| | 0.90 | 92 | 75 |
| | 2.7 | 100 | 95 |

*10% aqueous dmso was used as control

Example 3 shows the effect of ocimene concentration on the antifeedant/molluscicidal behaviour against D. reticulatum. In general there is an increase in mortality and a decrease in leaf disc consumption on increasing the ocimene concentration.

### Example 4

TABLE 4
Change in Feeding behaviour and mortality after treating
leaf discs with the cis isomer of β-Ocimene

| Sample | | Repellency Index | Corrected Mortality |
|---|---|---|---|
| description | Solvent | (%) | (%) |
| cis-β-Ocimene | Aq. Tween 80 | 84 | 15 |
| (0.35%) | (0.2%) | | |

Example 2 and 4 both indicate a strong repellent/antifeedant effect for the stereoisomers of β-ocimene (cis and trans). Comparing their solubilisation in aqueous tween 80 (0.5%) showed that the amount of lettuce leaf consumed was reduced by 73% for trans-β-ocimene and by 84% for the corresponding cis isomer. Low mortalities were obtained for both the trans and cis ocimene stereoisomers.

### Example 5

TABLE 5
Change in feeding behaviour after treating leaf discs with selected
mono and sesquiterpenes, solubilised in ethanol

| | Repellency | Corrected |
|---|---|---|
| | Index | Mortality |
| Sample description | (%) | (%) |
| trans-β-Ocimene (0.1%) | 5 | 0 |
| trans-β-Ocimene (0.45%) | 35 | 0 |
| trans-β-Ocimene (0.9%) | 95 | 5 |
| α-farnesene (0.7%) | 60 | 10 |
| α-farnesene (2.7%) | 97 | 50 |
| trans, trans farnesol (0.96) | 96 | 0 |
| cis, trans farnesol (0.95%) | 77 | 0 |
| Germacrene D (0.4%) | 77 | 0 |
| γ-bisabolene (0.7%) | 70 | 0 |
| Carophyllene (0.96%) | 40 | 15 |

All of the terpenes, solubilised in ethanol, gave a good measure of repellency against the feeding behaviour of D. reticulatuin, with the exception of the lower concentrations of ocimene (0.1 and 0.45%) and carophyllene yielding 5, 35 and 40% reduction in the consumption of lettuce leaf discs, respectively.

All the other terpenes tested gave over 70% repellency against the feeding molluscs. High slug mortalities (50%), using ethanol solvent, were observed when high levels of farnesene (2.7%) was applied to the lettuce leaf discs.

### Example 6

Commiphora guidotti (opoponax) essential oil contains high levels of the sesquiterpene α-santalene (22 to 26%). The alcoholic analogues (α and β santalols) occur at high levels in sandalwood essential oil. These alcohols, together, accounted for 90% of the essential oil chemical composition.

The antifeedant property of α and β santalol mixture is shown in the table below:

TABLE 6
Evaluation of the feeding behaviour and molluscicidal activity after
treating leaf discs with Santalol isomers (0.5% Sandalwood oil)
solubilised in aqueous dmso (10%)

| | | Repellency | |
|---|---|---|---|
| Sample | | Index | Corrected Mortality |
| description | Solvent | (%) | (%) |
| Sandalwood Oil | Aq. Dmso (10%) | 91 | 0 |
| (0.5%) | | | |

Example 6 signifies the potent repellent/antifeedant nature of sandalwood essential oil, when solubilised in aqueous dmso (10%). This change in feeding behaviour is considered to be due to the presence of alcoholic sesquiterpenes, α and β santalol, which together account for 90% of the total compounds present in sandalwood essential oil.

### Example 7

Spray Trials

Method

To evaluate the efficacy of trans-β-ocimene emulsions using peat substrates lettuce leaves were sprayed with 12 ml of an aqueous ocimene emulsion (3%). Once sprayed the leaves were placed in plastic trays containing peat soil and left for 30 minutes to remove the excess liquid drops. After this time period two adult slugs, previously starved for 24 hours, were added to each plastic tray and left for 24 hours.

A control (water) was treated similarly. Four replicates were prepared for each treatment.

Repellency indices were calculated as described for the leaf disc bioassay.

Results

TABLE 7
Evaluation of aqueous emulsions of trans-β-Ocimene as a repellent
spray against D. Reticulatum.

| | | | Mean | |
|---|---|---|---|---|
| | | Leaf | Leaf | Repellency |
| | Replicate | damage | damage | Indices |
| Treatment | No | (%) | (%) | (%) |
| trans-β-Ocimene | 1 | 0.99 | 7.25 | 76.5 |
| in water | 2 | 18.69 | | |
| (3%) | 3 | 9.33 | | |
| | 4 | 0.00 | | |
| Control | 1 | 57.64 | 30.86 | |
| | 2 | 33.28 | | |
| | 3 | 15.75 | | |
| | 4 | 16.77 | | |

FIG. 1 shows photographs of slug induced lettuce leaf damage, after spraying with 3% aqueous trans-β-ocimene. Examples 6 and 7 show the repellency effects observed when spraying lettuce with an aqueous emulsion of 3% trans-β-ocimene.

Significant protection, against the feeding activity of D. reticulatum molluscs, was observed over a 24 hour period (77%).

No mortality was observed in any of the peat saturated containers.

### Example 8

Example 7 was repeated wherein the lettuce leaves were sprayed with 5% trans-β-ocimene in Tween 20 and the anti-feedant properties tested on the garden snail H. aspersa.

5 and 10% Ocimene and Bisabolol (H. aspersa)

TABLE 8
Mollusc Repellency Properties Of Ocimene and Bisabolol Formulations
(5 and 10%)

| | | | % |
|---|---|---|---|
| | % Leaf | Repellency | Mortality ± |
| Sample description | Damage ± SEM | Index | SEM |
| 5% Ocimene oil/aq. | 2 ± 2* | 98 | 17 ± 7* |
| Synperonic (0.025%) | | | |
| 5% Ocimene/aq. | 0 ± 0* | 100 | 0 |
| Synperonic (5%) | | | |
| 5% Ocimene oil/aq. | 0 ± 0* | 100 | 0 |
| Tween 20 (5%) | | | |
| 5% Ocimene oil/Water | 79 ± 9 NS | 21 | 0 |
| 10% Ocimene oil/Water | 0 ± 0* | 100 | 5 |
| 1% α-bisabolol/aq. | 10 ± 0 | 90 | 0 |
| Tween 20 (1%) | | | |
| Control (Water) | 100 ± 0 | — | 0 |

n = 20 slugs per test condition, RI calculated relative to water,
*Significant difference (p < 0.05), NS = No significant difference (p > 0.05).

### Example 9

The same spray trial as in the previous examples was repeated and leaf damage monitored for 7 days. The results are shown below.

Spray Trial (Controlled Temperature Units) Monitoring Leaf Damage Over 7 Days (D. reticulatum)

TABLE 9
Monitoring amount of lettuce leaf damage caused by D. reticulatum
slugs, after spraying with oil emulsions

| | % Leaf Damage | | | | | | |
|---|---|---|---|---|---|---|---|
| Treatment | Day 1 | Day 2 | Day 3 | Day 4 | Day 5 | Day 6 | Day 7 |
| Control (Water) | 40 ± 4 | 50 ± 9 | 67 ± 8 | 69 ± 10 | 69 ± 10 | 73 ± 12 | 79 ± 13 |
| 5% Ocimene Oil | 0 | 0 | 0 | 0 | 0 | 0 | 0 |
| 3% Opoponax Essential | 0 | 0 | 1 ± 1 | 1 ± 1 | 3 ± 2 | 5 ± 3 | 7 ± 4 |
| Oil | | | | | | | |
| 3% Myrrh Essential Oil | 0 | 0 | 0 | 0 | 0 | 0 | 0 |
| 3% Myrrh (Ethanolic) | 2 ± 1 | 3 ± 1 | 10 ± 7 | 10 ± 7 | 16 ± 11 | 17 ± 12 | 19 ± 14 |

Spray Trial (Controlled Temperature Units) Monitoring Mortality Over 7 Days (D. reticitlatum)

TABLE 10
Spray Trial Monitoring of slug mortality over 7 days

| | % Mortality | | | | | | |
|---|---|---|---|---|---|---|---|
| | Days | | | | | | |
| Treatment | Day 1 | Day 2 | Day 3 | Day 4 | Day 5 | Day 6 | Day 7 |
| Control (water) | 0 ± 0 | 0 ± 0 | 0 ± 0 | 0 ± 0 | 7 ± 7 | 7 ± 7 | 7 ± 7 |
| 5% Ocimene Oil | 67± | 80 ± 12 | 87 ± 7 | 87 ± 7 | 93 ± 7 | 93 ± 7 | 93 ± 7 |
| 3% Opoponax Oil | 0 ± 0 | 40 ± 20 | 40 ± 20 | 40 ± 20 | 40 ± 20 | 40 ± 20 | 47 ± 18 |
| 3% Myrrh Oil | 53 ± 24 | 53 ± 24 | 67 ± 18 | 67 ± 18 | 80 ± 12 | 80 ± 12 | 87 ± 7 |
| 3% Myrrh (Ethanolic) | 7 ± 7 | 13 ± 7 | 13 ± 7 | 13 ± 7 | 27 ± 13 | 27 ± 13 | 27 ± 13 |

The leaf disc assay confirmed the antifeedent nature of the oils of myrrh, opoponax, sandalwood and ocimene aqueous emulsions. The feeding behaviors of both terrestrial molluscs (H. aspersa and D. reticulatum) were clearly modified, when offered lettuce leaf discs treated with these aqueous oil emulsions.

Pure ocimene oil was the only oil tested which, in addition to being a potent antifeedent, was also molluscicidal in nature resulting in 100% slug mortality immediately on contact.

All the spray trials, whether conducted in the laboratory, CT unit or greenhouse, reduced the consumption of lettuce leaves when myrrh, opoponax, sandalwood and ocimene oils were formulated as aqueous emulsions with nonionic surfactants.

### EXAMPLES

### Anti-Barnacle Agent

Investigations show that extract of Myrrh resin from Commiphora molmol and from scented Myrrh Commiphora guidotti or “Haddi”, are potent inhibitors of the settlement of the cyprid larvae of the marine barnacle Balanus amphitrite and therefore potential anti-barnacle agents. Similar results were also obtained for trans-β-Ocimene, a specific component of scented Myrrh. These examples are listed below:

Methods

The settlement of the barnacle Balanus Amphitrite was tested in multi-welled plates in the laboratory. Myrrh and scented Myrrh were extracted in ethanol and 2 ml aliquots from a range of concentrations (50% v/v to 1.5% v/v) were evaporated to dryness in each well of a multi welled plate. Ethanolic trans-β-Ocimene a component of scented Myrrh was also applied in the manner over a range of concentrations (50% v/v to 1.5-% v/v). After evaporation saltwater containing active cyprid larvae was introduced to each well and their settlement and activity measured after 24 hrs.

FIG. 2 shows the results of a settlement experiment using an extract from Haddi (Commiphora guidotti). After treatment with extract H from Haddi, the majority of larvae were classified as non-active after the 24 hr incubation. This means they are either dead or not moving with only slight internal movement. As the dose decreases, the level of non-active larvae decreases, while the level of active swimmer increases. This indicates a dose-dependent effect. There is no settlement except for 1 individual at the top concentration but this is probably a rogue. There was an oily meniscus on the surface of the wells, presumably from the extract. Overall, this extract at the concentrations tested is toxic to barnacle larvae (B. Amphitrite).

FIG. 3 shows the results of a settlement experiment using an extract from Myrrh (Commiphora molmol). Doses 50-12.5% v/v of extract M from Myrrh resulted in all the larvae becoming inactive. They were either dead or showing slight internal movement, but no limb movement. Doses 6.25 and 3.125% saw an increase in active larvae, with 3.125% having 84% active larvae and 16% settled. This indicates a dose-dependent response from the extract in terms of toxicity.

FIG. 4 shows the results of a settlement experiment performed using compound trans-β-Ocimene (from Commiphora guidotti). Compound O (trans-β-Ocimene) had some unusual effects on the larvae. This was possibly caused by an osmotic change as the body had swollen and increased in size and was too large for the cuticle, resulting in a strange ‘mutation’ effect. At the top two doses the larvae were all floating on the surface but were ‘mutated’. As the dose decreased, the % non-active (including mutations) decreased and the amount of active and settled larvae increased, again indicating a dose-dependent response.

Both the ethanol and seawater controls (FIG. 5) showed the majority of larvae active, with a small amount of settlement and viruually no dead larvae indicating a healthy batch of larvae was used in the experiment.

The barnacle settlement experiments were repeated; however, this time 10 Balanus amphitrite day 3 cyprids were incubated in varying concentrations (10⁻⁵-10⁻⁹M) of trans-β-ocimene at 28° C. in dark conditions. Each concentration was replicated four times, with a control run. The number of cyprids that had settled, still active, floating on the surface meniscus or dead was counted after 24 and 48 hr incubations. Results are expressed as a % of the total cyprid number in each well minus floating cyprids, as these were unable to settle. Values are expressed as mean ±SEM. The amount of settlement at each concentration was compared to the control settlement using an unpaired t-test.

Results

Ocimene caused inhibition of settlement in a reverse dose-dependent manner after 24 hr (FIGS. 6 and 7), with the lowest concentration (10⁻⁹M) being statistically different from the control.

Conclusions

All the extracts tested had an inhibitory dose-dependent effect on larval settlement. Whether this is caused by toxic effects and is lethal or is inhibitory and reversible when removed from the solution is unclear. Further experiments at lower concentrations need to be carried out. Extract H appeared to have the best effect, as there was no settlement even at the lowest dose. Further individual compounds from this extract are currently being tested.

All documents cited above are incorporated herein by reference.

1. A composition comprising an isolated compound in combination with one or more carriers for use as a molluscicidal and/or mollusc-repellant agent, wherein the compound is a terpene or oxygenated derivative thereof, the terpene is selected from the group consisting of: 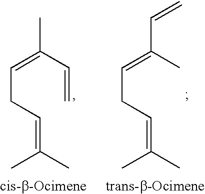
monocyclic sesquiterpenes of the bisabolene, bisabolol or germacrene type; and bicyclic sesquiterpenes of the santalene or carophyllene type.

2. The composition of claim 1, wherein the compound is

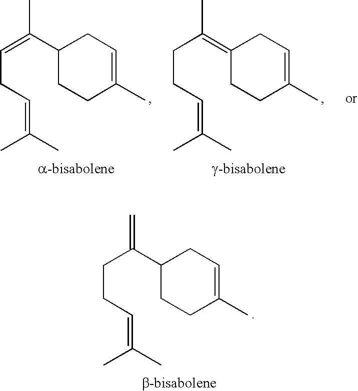

3. The composition of claim 1, wherein the compound is

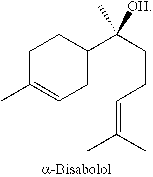

4. The composition of claim 1, wherein the compound is

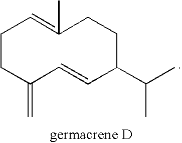

5. The composition of claim 1, wherein the compound is selected from the group consisting of:

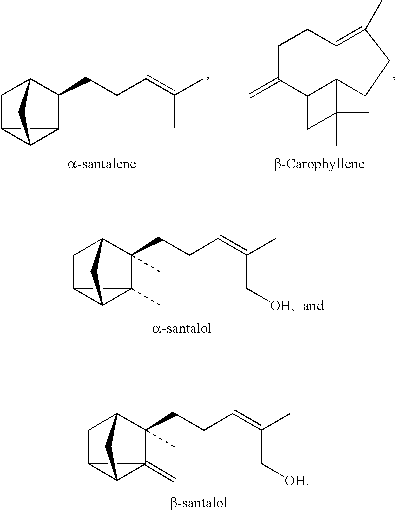

6. The composition according to claim 1, wherein the carrier is a heterologous carrier.

7. The composition according to claim 1, wherein the compound is obtained from a plant in in a genus selected from the group consisting of Detarium, Ximenia, Polygonum, Commiphora and Boswellia.

8. The composition according to claim 7, wherein the plant is of a species selected from the group consisting of Detarium microcarpum, Ximenia americana, Polygonum limbatum, Commiphora molmol, Commiphora guidotti, and Boswellia sp.

9. The composition according to claim 8, wherein the plant is Commiphora molmol or Commiphora guidotti.

10. The composition according to claim 1, wherein the carrier is a particulate.

11. The composition according to claim 10, wherein the particulate is selected from the group consisting of sand, sharp sand, pumice granules, sawdust, wood chips and corncob chips.

12. The composition according to claim 10, wherein the particulate is sawdust.

13. The composition according to claim 1, wherein the composition is in a formulation capable of being sprayed.

14. The composition according to claim 13, wherein the carrier is an aqueous solution comprising between 1 and 10% alcohol in water.

15. The composition according to claim 1 further comprising an effector agent.

16. The composition according to claim 15 wherein the effector agent is a fertiliser or a pesticide.

17. The composition according to claim 1, which contains between 0.1 and 5% (v/v) compound.

18. The composition according claim 17, which contains between 0.1 and 3% (v/v) compound.

19. The composition according to claim 18, which contains between 0.25 and 1% (v/v) compound.

20. A method of killing or repelling mollusks comprising: applying the composition according to claim 1 to a mollusk or a surface that contacts mollusks whereby the mollusk is killed or repelled.

21. The method of claim 20 wherein the isolated compound is a terpene or oxygenated derivative thereof, and the terpene is selected from the group consisting of: 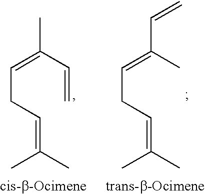
monocyclic sesquiterpenes of the bisabolene, bisabolol or germacrene type; and
bicyclic sesquiterpenes of the santalene or carophyllene type.

22. The method according to claim 21 wherein the compound is combined with one or more carriers.

23. The method according to claim 21 wherein the compound is applied in combination with one or more effector agents.

24. The method according to any of claims 20 wherein the mollusk is aquatic or terrestrial.

25. A method of killing or repelling barnacles comprising: applying to a barnacle or a surface that contacts barnacles a plant material derived from a plant in a plant family selected from the group consisting of Caesalpiniaceae, Olaceae, Polygonaceae and Bursecaceae wherein the plant material has as an anti-barnacle effect.

26. The method according to claim 25, wherein the plant material is obtained from a plant in a genus selected from the group consisting of Detarium, Ximenia, Polygonum, Commiphora and Boswellia.

27. The method according to claim 26, wherein the plant is of a species selected from the group consisting of Detarium microcarpum, Ximenia americana, Polygonum limbatum, Commiphora molmol, Commiphora guidotti and Boswellia sp.

28. The method according to claim 27, wherein the plant is Commiphora molmol or Commiphora guidotti.

29. The method according to 25 wherein the plant material is in the form of particles or a powder.

30. The method according to claim 25, wherein the plant material comprises substantially the whole plant.

31. The method according to claim 25, wherein the plant material comprises bark, leaves or a shoot of the plant.

32. The method according to claim 25, wherein the plant material is an alcoholic extract of the plant.

33. The method according to claim 32, wherein the plant material is an alcoholic extract of the essential oil of the plant.

34. The method according to claim 25, wherein the plant material is a substantially isolated compound.

35. The method according to claim 34, wherein the substantially isolated compound is applied in combination with a carrier.

36. The method according to claim 25, wherein the plant material is applied in combination with an effector agent.

37. The method according to claim 25 wherein the plant material is applied as a paint-like preparation.

38. An anti-barnacle composition comprising an isolated compound and one or more carriers for use as an anti-barnacle agent, wherein the compound is a terpene or oxygenated derivative thereof, and the terpene is cis-β-ocimene or trans-β-ocimene.

39. The composition according to claim 38, which is suitable for applying to surfaces that come into contact with barnacles.

40. The composition according to claim 38, which contains between 0.1 and 50% (v/v) compound.

41. The composition according to claim 40, which contains between 3 and 25% v/v compound.

42. The composition according to claim 41, which contains between 6 and 25% v/v compound.

43. The composition according to claim 38 further comprising an effector agent.

44. A method of treating or repelling barnacles. Comprising: applying a composition according to claim 38 to barnacles or to a surface that comes into contact with barnacles, whereby barnacles are killed or repelled.

45. The method of claim 44 wherein the compound is cis-β-ocimene, trans-β-ocimene.

46. The method according to claim 45, wherein the compound is applied with one or more carriers.

47. The method according to claim 45 wherein the compound is applied with an effector agent.

48. A method of forming a stable water emulsion comprising an essential oil, a surfactant and water, wherein the essential oil and the surfactant are mixed together prior to addition of the water.
